(19) United States
(12) Patent Application Publication
(10) Pub. No.: US 2016/0076921 A1
(43) Pub. Date: Mar. 17, 2016

(54) CIRCULAR INDICATOR

(71) Applicant: David A. KRA, Jerusalem (IL)

(72) Inventor: David A. KRA, Jerusalem (IL)

(21) Appl. No.: 14/725,090

(22) Filed: May 29, 2015

Related U.S. Application Data
(60) Provisional application No. 62/049,322, filed on Sep. 11, 2014.

(51) Int. Cl. G01D 13/02

(52) U.S. Cl. CPC G01D 13/02

(57) ABSTRACT

Embodiments of this invention comprise circular indicators with one circular scale having M markings which align with H markings on another concentric circular scale, for M>H+1. This alignment enables the indicators, such as a clock face, to indicate both major and minor units (e.g., hours and minutes) by rotating the scales relative to each other rather than by utilizing two hands. The minor marker alignment encircles the major unit markers many times over the course of one major unit of rotation. The adjacency sequence of minor unit values is not monotonic around the disk, and the angles between adjacent minor markers are not all equal. The counts of major markings and minor markings need not be relatively prime numbers.

### CROSS REFERENCES TO RELATED APPLICATIONS

This application claims the benefit of United States Provisional Application For Patent, Ser. No. 62/049,322, filed Sep. 11, 2014, and whose contents are incorporated by reference herein in their entirety.

### FIELD OF THE INVENTION

This invention relates to the field of indicator panels, and more particularly, to the field of circular indicators with markings to increase the accuracy to which readings can be made.

### BACKGROUND OF THE INVENTION

Indicator panels, such as gauges, clock faces and other dials are often required to have indications that must be to a high level of accuracy. For example, indications of 1 part in 1000 or 1 part in 720 (or 720 minutes in 12 hours) are common. The indicators typically have major and minor units such as hours and minutes or quarter circle and degrees. There are often more minor units per major unit than there are major units. For example, a common clock face has 60 minor units (minutes) and 12 major units (hours).

Prior art devices, such as clocks, commonly use two rotating pointers (“hands”), one for major units (hours) and another for minor units (minutes). The indication is provided by cooperatively interpreting the reading provided by each pointer.

Prior art attempts at creating circular indicators that are both accurate and easily usable have had the following shortcomings and differences:
(1) The indicators typically utilize a vernier scale approach, in which the quantity of markings on the vernier scale is one (1) more or less than the number of markings on the comparison scale;
(2) The markings on the device are very small and close together;
(3) The markings are repeated several times;
(4) The devices fail to depict uniquely the value to be indicated and
(5) Minor units are depicted on both the face and the dial.

Some prior art uses one dial with a vernier scale. See, e.g., http://www.gizmology.net/watch.htm. The smaller units are depicted on a very small or fine scale. The markings are very close together. Each circular arc vernier scale always spans less than 360 degrees around the circle. Thus, it is extremely difficult, and perhaps impossible, to obtain accurate indications.

Other prior art is a device that gives multivalued ambiguous readings, which are confusing and realistically unusable by the person reading this device. See, e.g., http://www.gizmology.net/watch.htm.

Further, existing devices often place the minor markings (e.g., minutes) on the indicator's static face or on both the static face and the rotating dial. See, e.g., http://www.gizmology.net/watch.htm.

Vernier micrometers, use linear scales inscribed on the outer cylinder of a thimble and vernier scale markings inscribed closely together on a small portion of the sleeve. See., e.g., http://www.auto-met.com/mitutoyo/how_to_read_micrometers.htm.

There existed a single handed timepiece with a sinusoidal display. To indicate major and minor units with one hand, it used both radial and rotational mechanical motion of an indicator. It had closely spaced separate positions for each minor division. It was mechanically complex.

Further, in the prior art, all the vernier markings are always visible, not only the few markings that are most relevant. This is a distraction to the observer.

Prior art has equal angular spacing between all adjacent minor markings, e.g., 6 degrees between minute markers on a standard 12 hour clock face.

Thus, prior art circular vernier indicators fail to be both accurate and easily usable.

### BRIEF SUMMARY OF THE INVENTION

An object of this invention is a circular indicator or gauge that provides unambiguous accurate readings even when there are more minor units per major unit than there are major units.

Another object of this invention is a circular indicator or gauge that has easily usable, widely spaced markings.

Still another object of this invention is a circular indicator or gauge that eliminates the need for some duplicate markings.

A further object of this invention is a circular indicator or gauge which eliminates the need for separate moving parts to indicate major and minor measurement units.

Still another object of this invention is a circular indicator or gauge which hides or masks most markings that are irrelevant to determining the current value being displayed and that might distract the observer.

A further object of this invention is a circular indicator or gauge whose assembly is facilitated by aids promoting proper alignment of its parts.

Briefly, this invention is a circular indicator or gauge which is accurate, unambiguous, easily usable, easily assembled, and mechanically simple.

The indicator comprises two physical parts: a static face and a rotating dial. The static face needs markings only for the major units of measurement (e.g., 12 markings for the hours). The rotating dial has markings to indicate the measurement in both the major and minor units (e.g., hours and minutes).

This invention improves upon the prior art circular indicators in various ways, including without limitation, the following:
(1) The minor markings are spread around the disk, not compressed into a small arc of the disk.
(2) Fewer minor markings are required.
(3) Adjacent minor markings are not for adjacent numbers.
(4) Adjacent minor markings are not uniformly spaced apart.
(5) Numeric minor markings use symbols that can be read from any angle.
(6) Irrelevant markings are masked to improve readability.
(7) Appropriately shaped major and minor markings make it easy to notice which measurement values are just above and just below the indicated value.
(8) A novel “randomized” implementation is available.

In short, embodiments of this invention comprise indicators with one circular scale having M markings which align with H markings on another concentric circular scale, for M>H+1. This alignment enables the indicators, such as a clock face, to indicate both major and minor units (e.g., hours and minutes) by rotating the scales relative to each other rather than by utilizing two hands. The minor marker alignment encircles the major unit markers many times over the course of one major unit of rotation. The adjacency sequence of minor unit values is not monotonic around the disk, and the angles between adjacent markers are not all equal.

In addition, the counts of major markings and minor markings need not be relatively prime numbers; in prior art vernier scales, the counts of markings are required to be relatively prime numbers.

Thus, this invention differs from and eliminates shortcomings of the prior art.

### BRIEF DESCRIPTION OF THE SEVERAL VIEWS OF THE DRAWING

FIG. 1 shows a static 12 hour clock face for use in an embodiment of this invention.

FIG. 2 shows a direct clock dial for use in an embodiment of this invention.

FIG. 3 shows a retrograde clock dial for use in an embodiment of this invention.

FIG. 4 shows a randomized retrograde clock dial for use in an embodiment of this invention.

FIG. 5 shows the direct clock dial shown in FIG. 2, indicating the time of 6:14.

FIG. 6 shows the retrograde clock dial shown in FIG. 3, indicating the time of 2:38.

FIG. 7 shows the randomized retrograde clock dial shown in FIG. 4, indicating the time of 2:38.

FIG. 8 shows a compass face embodiment of this invention containing four (4) major markers.

FIG. 9 shows a compass dial embodiment of this invention containing ninety (90) degrees per quadrant.

FIG. 10 shows the compass dial shown in FIG. 9, indicating the direction of 45 degrees south of east.

FIG. 11 shows a reversed role rotating clock dial with major and minor alignment markers for use in an embodiment of this invention.

FIG. 12 shows a reversed role direct clock face with major and minor values for use in an embodiment of this invention.

FIG. 13 shows a reversed role retrograde clock face with major and minor values for use in an embodiment of this invention.

FIG. 14 shows a reversed role retrograde clock face, indicating the time of 6:13 for use in an embodiment of this invention.

FIG. 15 shows a reversed role direct clock face, indicating the time of 6:13 for use in an embodiment of this invention.

### DETAILED DESCRIPTION OF THE INVENTION

In this Specification, the term “direct” is used for indicators where both major and minor units proceed in the same rotational sense, e.g., clockwise. The term “retrograde” is used where the major units proceed in one sense while the minor units proceed in the other.

Prior art circular indicators are typically made as “direct indicators” such that the major and minor units both proceed forward in the same sense. In contradistinction, this invention may be either a “direct indicator” or a “retrograde indicator” where the minor units proceed in the opposite sense (e.g., counterclockwise) from the major units. This flexibility exists even though both the major and minor units are depicted on the same physical disk. This invention's circular retrograde indicators present the apparent paradox of having the minor sequence going counter to the major sequence and counter to the physical rotation of the disk. This option is appropriate primarily for “novelty” indicators.

An embodiment of this invention is a circular indicator or gauge. It comprises a static face and a rotating dial. The rotating dial is concentrically mounted above the static face. In this embodiment, the only markings necessary on the static face are for the major units of measurement, e.g., 12 markings to indicate hours. The rotating dial has markings to indicate the measurement in both the major and minor units, e.g., hours and minutes.

The major unit value is preferably determined as follows: There is a mark on one scale, different from all other marks on that scale, that points to a major mark or between marks on the other scale, or to the position, where, by convention the mark for a particular value would be. Numerical values associated with each mark are usually present, but may be omitted in cases of widely accepted prior art convention.

The minor unit value is preferably determined as follows: One of the many minor markings on one scale most closely aligns with one of the major markings on the other scale. The value associated with the minor marking is depicted near the minor marking by printing, engraving, etching, embossing, or other similar techniques well known in the prior art.

The major scale is preferably distinguished from the minor scale in one or more of the following ways:
(a) The minor scale has more markings than the major scale.
(b) Markings on the minor scale are closer together.
(c) Adjacent minor markings are not all equally spaced.
(d) On the minor scale, when proceeding around the scale from the lowest value to the highest, at least one value is lower than the value adjacent to it, in addition to the transition from the highest value back to the lowest.

This embodiment comprises an indicator showing “h” major units and “m” minor units on the indicator. For a setting to i major units and j minor units, the rotational displacement angle alpha between the dial and the face is

Alpha=i*(360/h)+j*(360/(h*m)) degrees

### Static Face

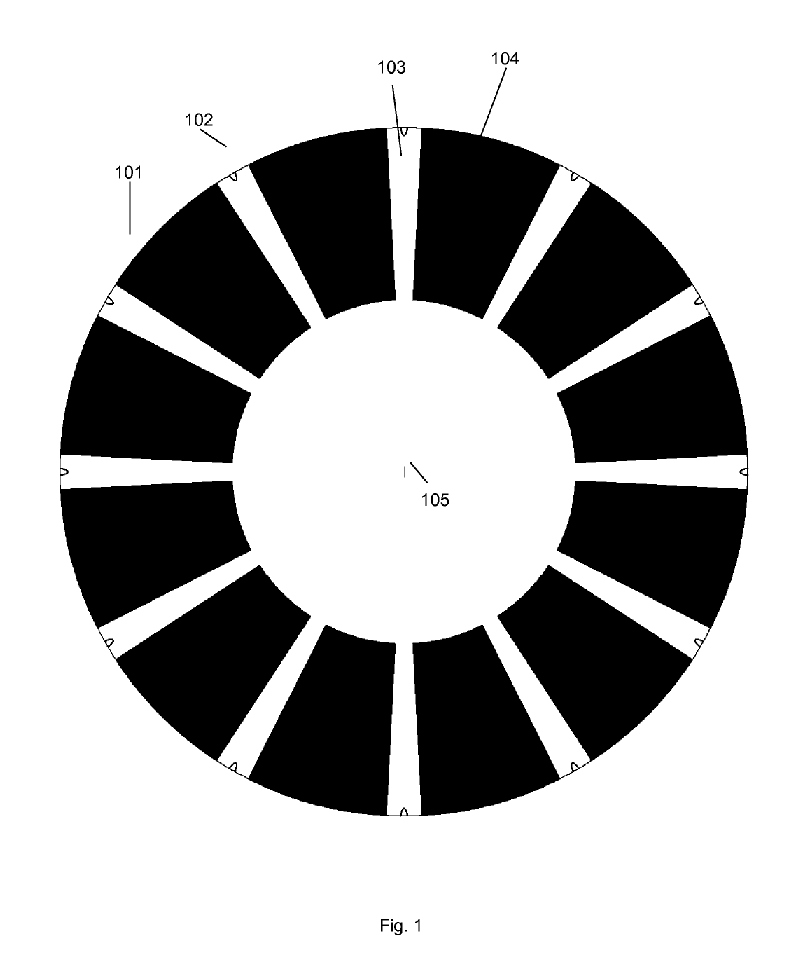

An embodiment of the static face component is shown in FIG. 1. In this embodiment, the static face is an opaque disk 101 of radius r. Except for markings and darkened segments, the disk is a color, preferably white, that will facilitate noticing the markings on the rotating dial. Markings are thick enough to be seen at the observer's normal distance from the device.

The static face 101 has a total of “h” markings 102 around it, which may be numbered or labeled, to indicate major values, e.g., hours, or major compass headings e.g., North, East, South, West. A 12-hour clock face has h=12. A compass dial with 4 headings has h=4. The h markings are evenly spaced 360/h degrees apart around the entire circumference of the static face 101.

Preferably, each major value marker 102 has a contrasting space 103 in its middle which aids the user in seeing when a minor indicator is reaching, centered on, or passing the major marker.

The static face 101 preferably has h darkened sections 104. Except for the 180/m degrees on either side of the major markings, these sections 104 cover the central ring of the static face. These darkened sections 104 facilitate reading the indicator by hiding minor markings that are irrelevant to the then current reading.

In this embodiment, the center of the static face 101 is marked with cross hairs 105 which facilitate exactly centered drilling of a hole that will accommodate the shaft for the rotating dial.

### Rotating Dial

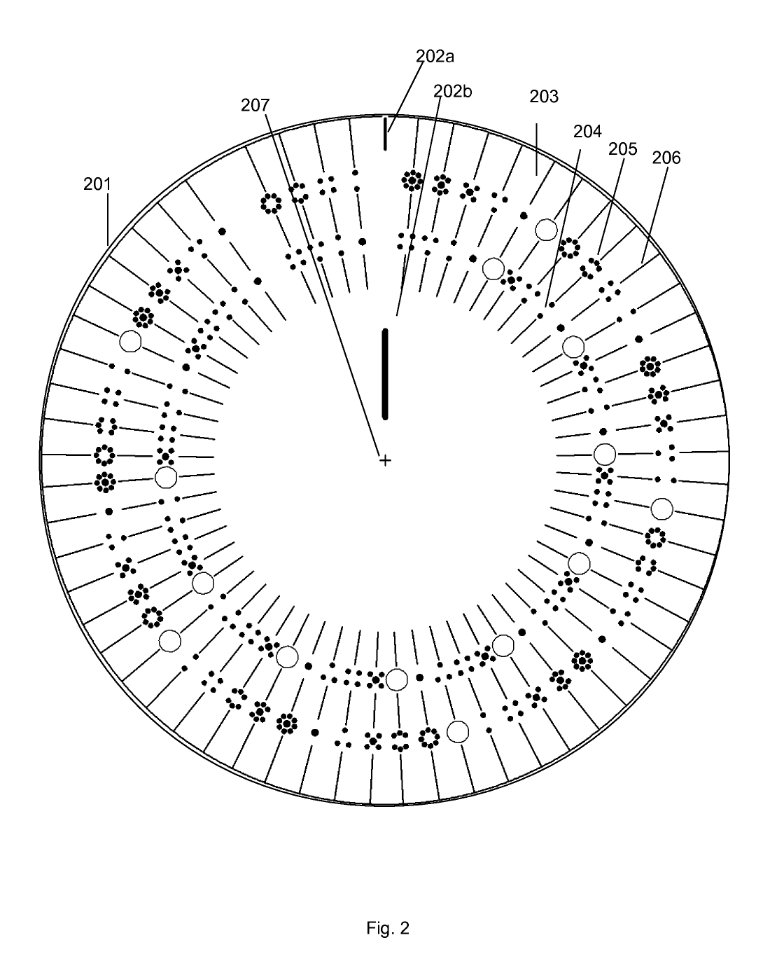

A 12 hour clock face embodiment of the rotating direct dial is shown in FIG. 2. This rotating dial has markings to indicate hour and minute. The minor indication alignments (e.g. minutes) proceed clockwise as the dial rotates clockwise once per h major units (e.g. 12 hours).

This embodiment is preferably a transparent disk 201 having radius “r”.

The markings on the rotating dial 201 are a color, e.g., black, that may be readily visible over the static face 101, except for the markings above the static face's darkened sections 104. The markings are thick enough to be seen at the observer's normal distance from the device.

The major unit of measurement is indicated on the rotating dial 201 by a marker 202a or 202b. This major unit is analogous to a clock face's hour hand or compass dial's pointer. Alternatively, if the marker 202a or 202b is placed so as to sometimes be positioned over dark sections of the static face 104, then the major unit indicator must be outlined in a light opaque pattern or color, e.g., white. This outlining will prevent the marker 202a or 202b from becoming very difficult to see at some positions.

The minor unit of measurement is indicated on the rotating dial 201 by m−1 minor unit indicators 203 spread precisely around the rotating face 201. These minor indicators 203 are positioned so that for each minor unit value to be indicated, there is only one minor unit indicator in exact alignment with any major unit mark on the static face 101; the minor unit value is read from the minor unit indicator in this exact alignment.

Angular placement of the minor unit indicators is specified in terms of degrees from the major unit indicator. The specification for many of the minor unit indicators will be as angles greater than 360 degrees or less than −360 degrees. For convenience, they can also be expressed modulo 360.

(A) For direct (forward) indication (see FIG. 2), minor unit j is positioned at angle

alpha=j*360*(m−1)/(h*m) degrees

from the major unit indicator. Angle alpha is greater than 360 degrees when

j>(h*m)/(m−1)

For an embodiment comprising a direct clock face with h=12 and m=60:

alpha=29.5*j degrees;

For j greater than 12, alpha is greater than 360 degrees.

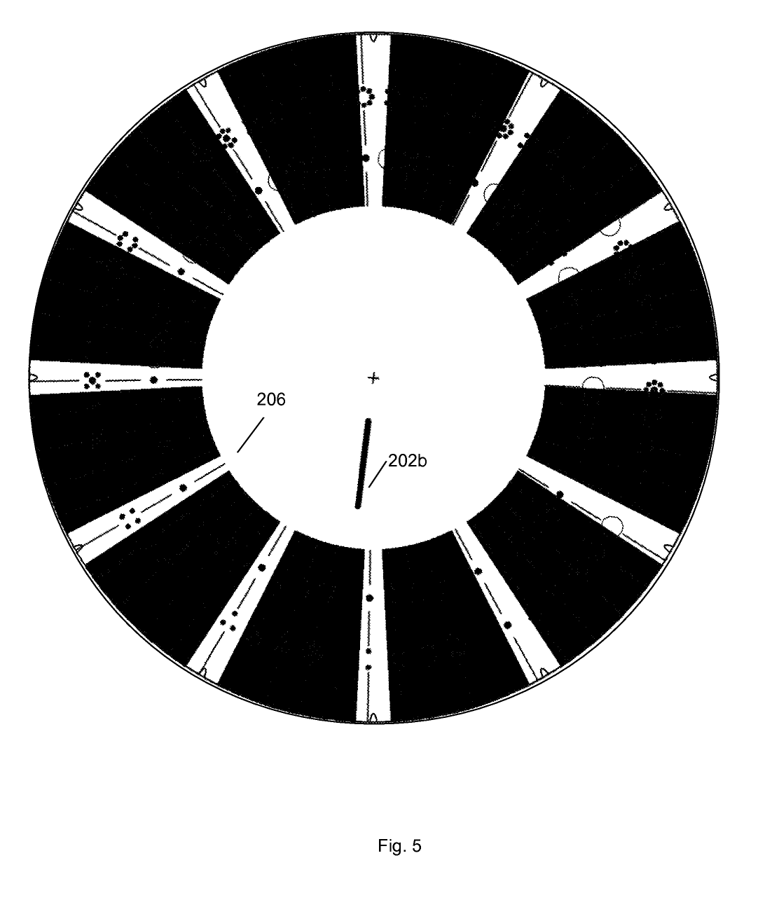

See FIG. 5 for a sample reading indicating the time of 6:14. The major indicator marker 202b is almost 25% of the way between the 6 and 7 o'clock markers. Minor indicator marker 206 aligns with the 8 o'clock marker.

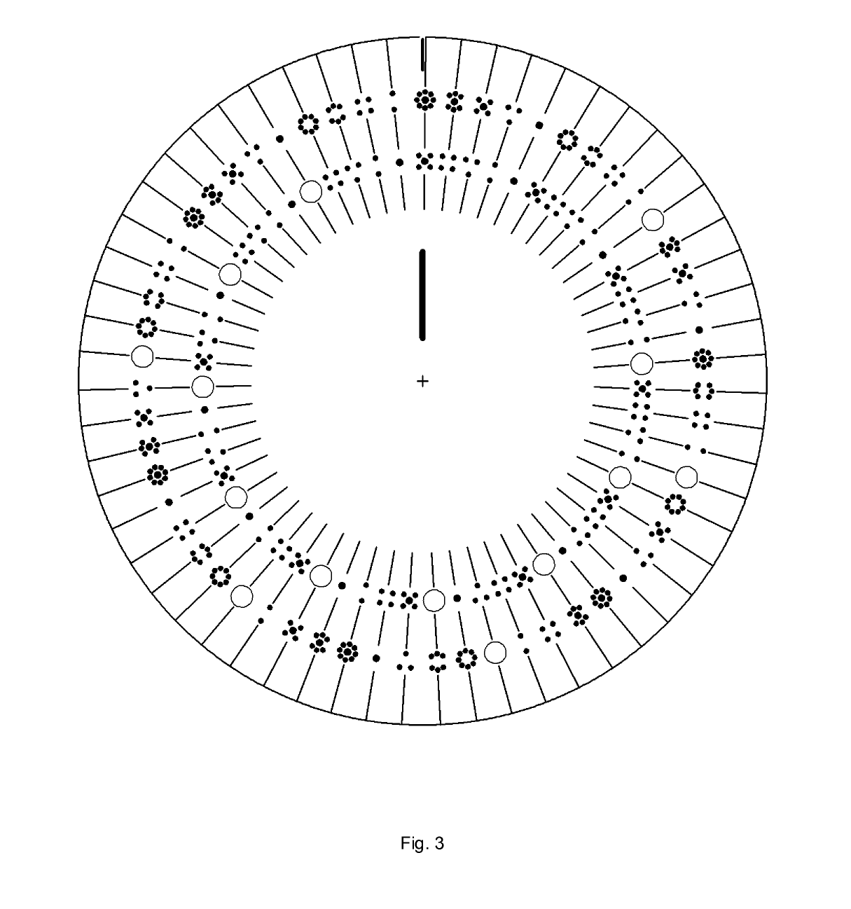

(B) For a 12 hour clock face embodiment with retrograde indication (see FIG. 3), where the rotating retrograde dial has markings to indicate hour and minute, the minute indication alignment proceeds counterclockwise as the dial rotates clockwise once per 12 hours. The minor unit j is positioned at angle

alpha=−j*360*(m+1)/(h*m) degrees

from the major unit indicator. Angle alpha is less than −360 degrees when

j>(h*m)/(m+1)

For a retrograde clock face with h=12 and m=60:

alpha=−30.5*j degrees;

For n greater than 11, alpha is less than −360 degrees.

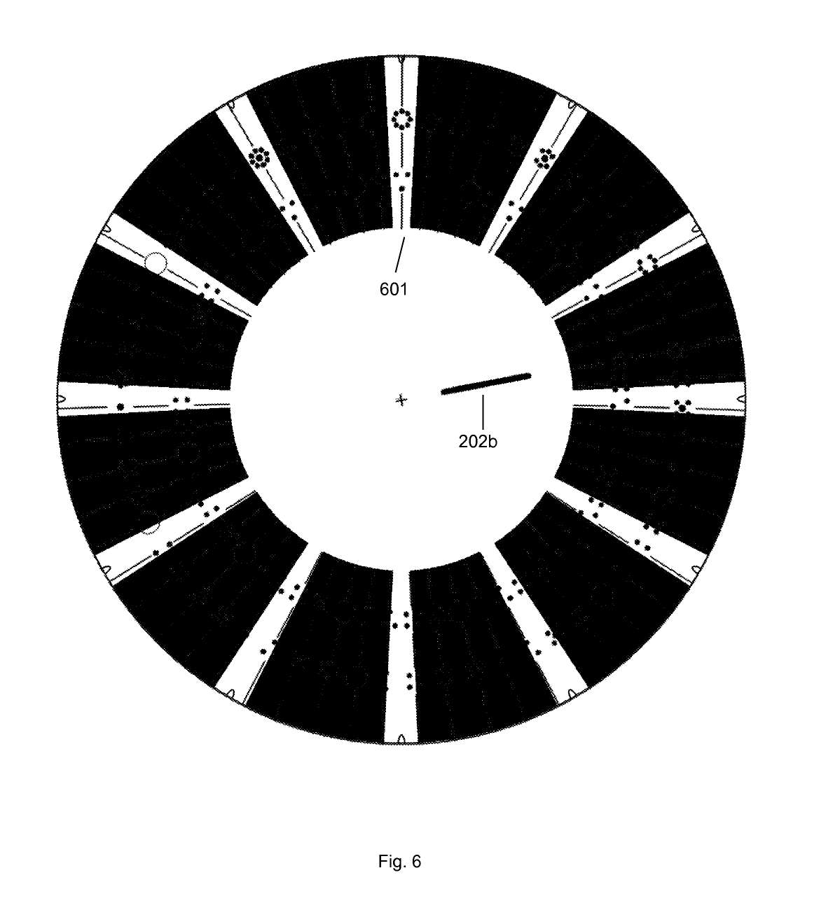

See FIG. 6 for a sample reading indicating the time of 2:38. The major indicator marker 202b is almost approximately 66% of the way between the 2 and 3 o'clock markers. Minor indicator marker 601 aligns with the 12 o'clock marker.

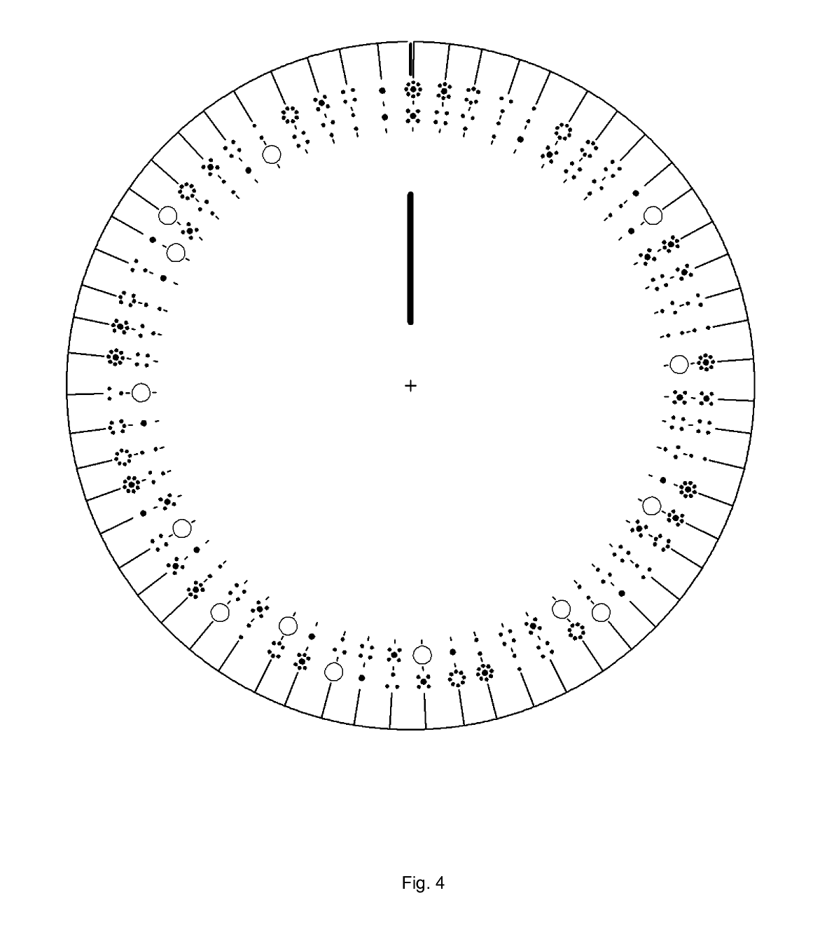

(C) For a randomized indicator dial embodiment (see FIG. 4), start with a direct or retrograde dial. Reposition some minor indicators so that when their values are to be indicated, they align with fixed face major markers other than would be normal on the original direct or retrograde indicator. Nevertheless, keep minor value indicators from being too close together.

Thus, the minute indication alignment proceeds randomly as the dial rotates clockwise once per 12 hours. The random sequence repeats itself every hour.

The straightforward way to accomplish this is to randomly choose to swap or not swap which major markers align with minor indicators j and j+1 for odd j.

For a direct clock dial, this can be expressed as:

```
If (swap) then
    {
    Add (360/h) degrees to the angle for minor
    value indicator j;
    Subtract (360/h) degrees from the angle for
    minor value indicator j+1;
}
```

For a retrograde clock dial, this can be expressed as:

```
If (swap) then
    {
    Subtract (360/h) degrees from the angle for
    minor value indicator j;
    Add (360/h) degrees to the angle for minor
    value indicator j+1
    }
```

For a clock face embodiment with h=12 and m=60, even if the last pair (59, 0) is never swapped, there are 29 pairs, each of which may or may not be swapped. This gives a total of 2²⁹=536,870,912 unique clock dials.

In FIG. 4, the following minor indications have swapped which major indicator they align with:
1 & 2,
5 & 6,
7 & 8,
11 & 12,
13 & 14,
15 & 16,
19 & 20,
21 & 22,
27 & 28,
29 & 30,
35 & 36,
37 & 38,
49 & 50, and
55 & 56.

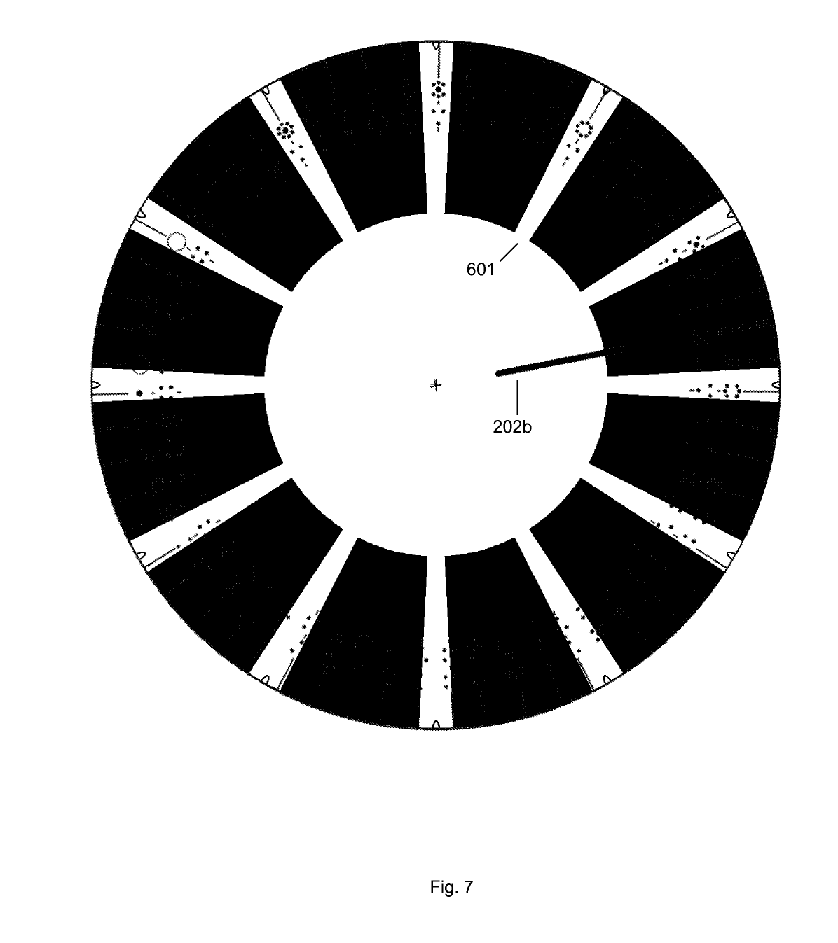

See FIG. 7 for a sample reading indicating the time of 2:38. The major indicator marker 202b is almost approximately 66% of the way between the 2 and 3 o'clock markers. Minor indicator marker 601 aligns with the 1 o'clock marker.

Each minor unit indicator is labeled with its numeric value, i.e., 204, 205. The preferred embodiment uses symbols that are easily readable from any orientation. Instead of Arabic numeral digits, the preferred embodiment uses symbols similar to dominoes. An empty circle represents zero. Arbitrarily, the example embodiment places the 10's digit symbol 204 closer to the dial's center and the 1's digit 205 closer to the perimeter.

Each minor unit indicator has a line segment 206 that extends from its value label to the major unit markers on the static face.

In use, in doing a reading from the invention, the major unit of measurement is determined by examining the rotating dial 201 and visually locating the marker 202a or 202b. The position of the marker 202a or 202b is compared to a set of known locations around the rotating dial 201, each of which corresponds to a value of the major unit of measurement. For example, on a clock face, the locations are the hour values. This value of the major unit of measurement then equals the known value at the location where the marker 202a or 202b is found.

The minor unit of measurement is determined by examining the rotating dial 201 and locating the only minor unit indicator which is in exact alignment with a major unit mark on the static dial 101. For example, on a clock face, the minor unit of measurement is the minutes value. The minor unit value is read from the minor unit indicator in this exact alignment relationship.

### Compass Dial

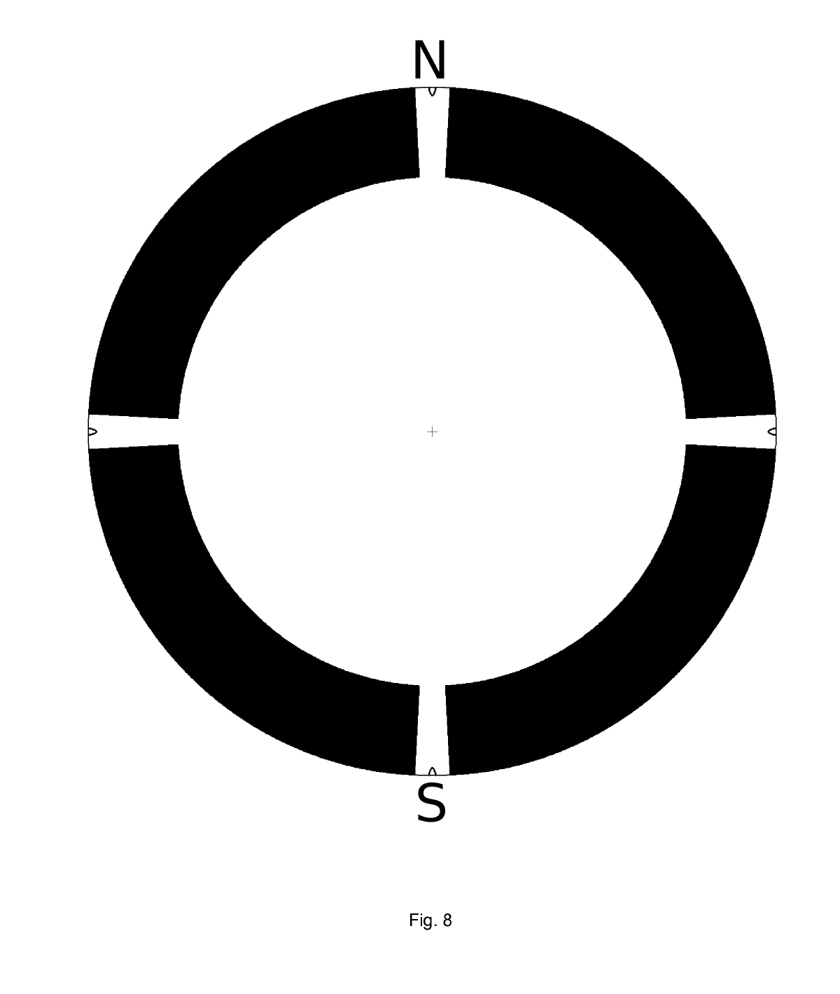

For example, another embodiment of this invention comprises a compass dial. The static face is shown in FIG. 8, which illustrates a static compass face with 4 major markers. There is a major marking for every quadrant of the circle.

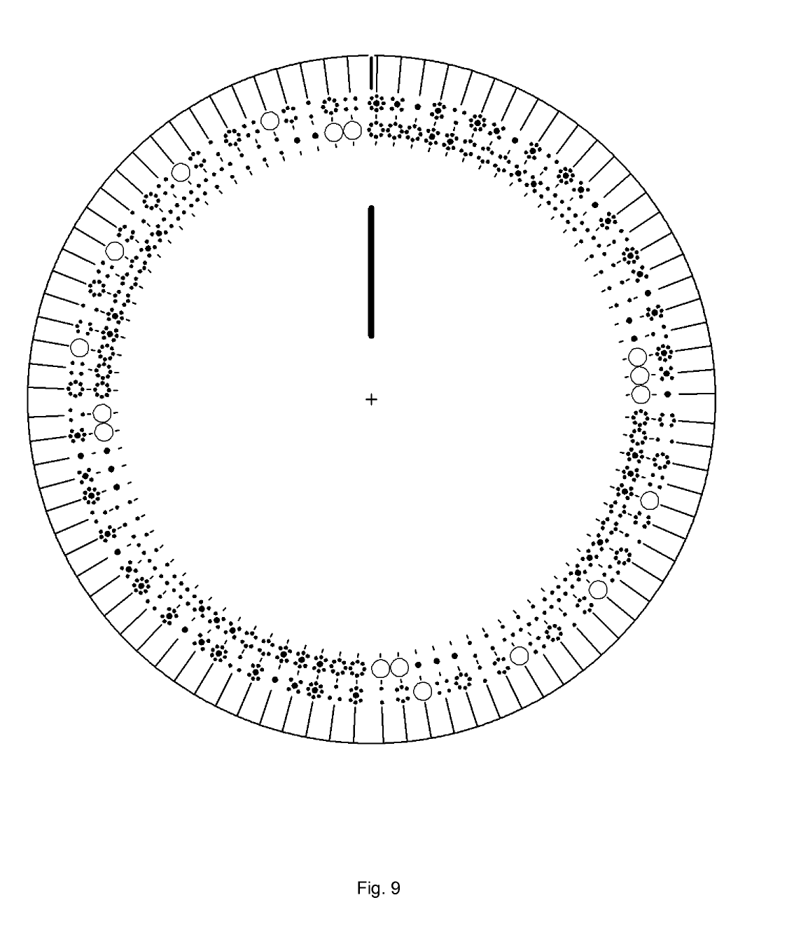

The rotating direct compass dial is shown in FIG. 9, which has 90 degrees per quadrant. The rotating dial indicates the quadrant and degrees within the quadrant. Degree indications proceed clockwise as the dial rotates clockwise.

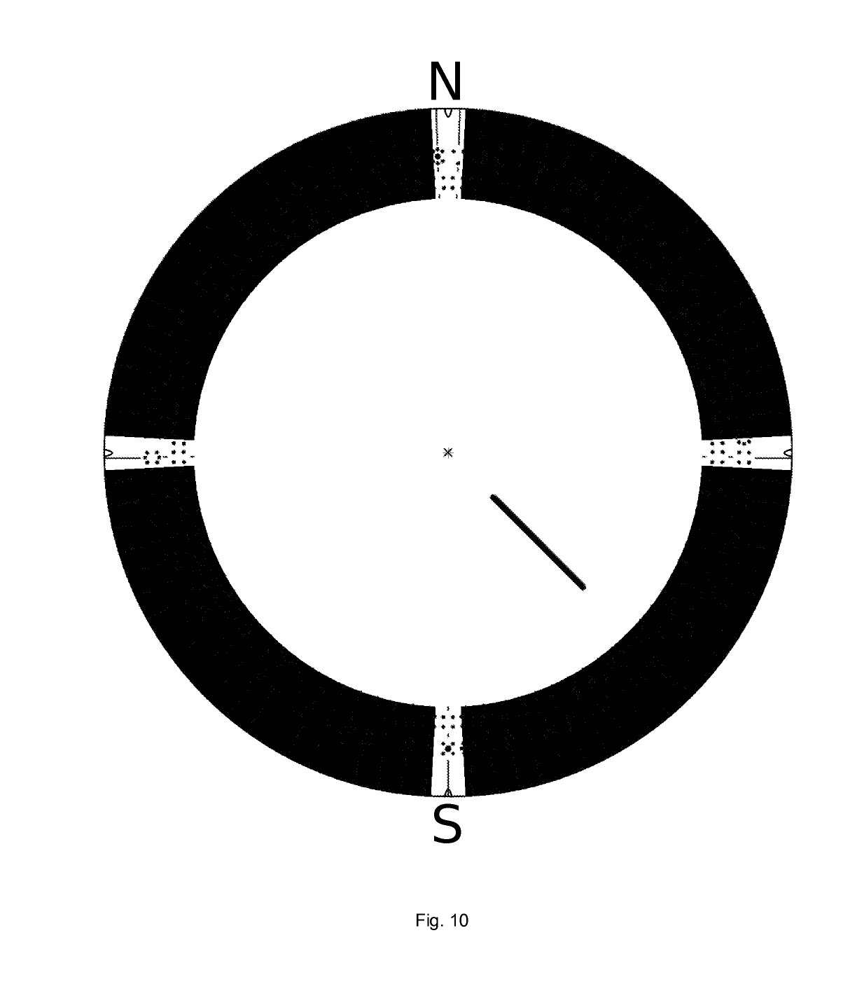

See FIG. 10 for a sample reading indicating the direction 45 degrees south of (or below) east.

### Additional Features

Additional features of these embodiments are that the center of the rotating dial is marked with cross hairs 207 and the center of the static face is marked with cross hairs 105 to facilitate exactly centered drilling of a hole that will accommodate the shaft for the rotating dial.

### Another Embodiment

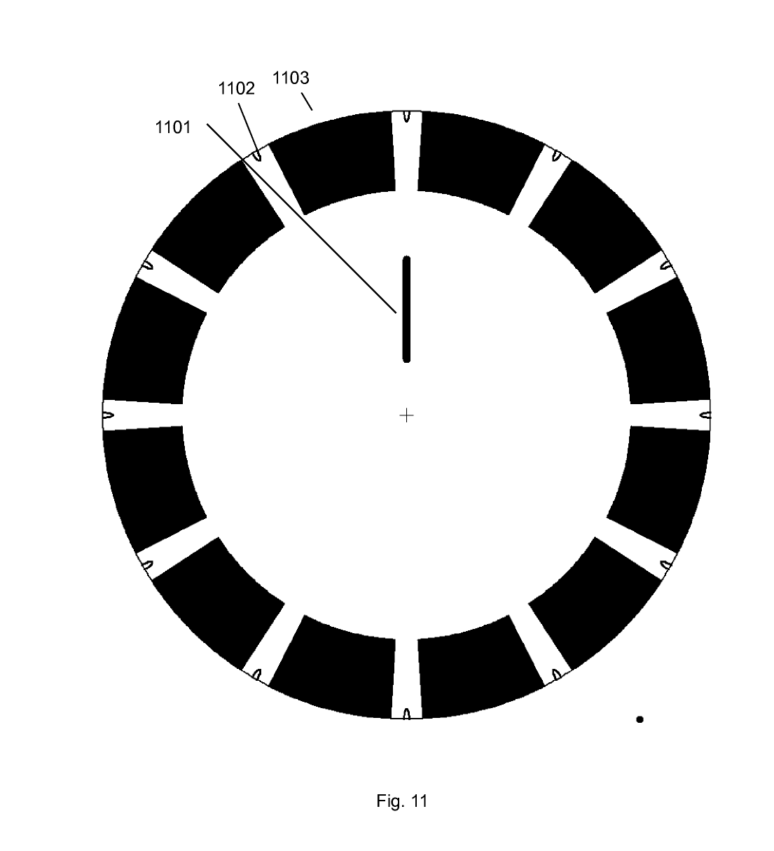

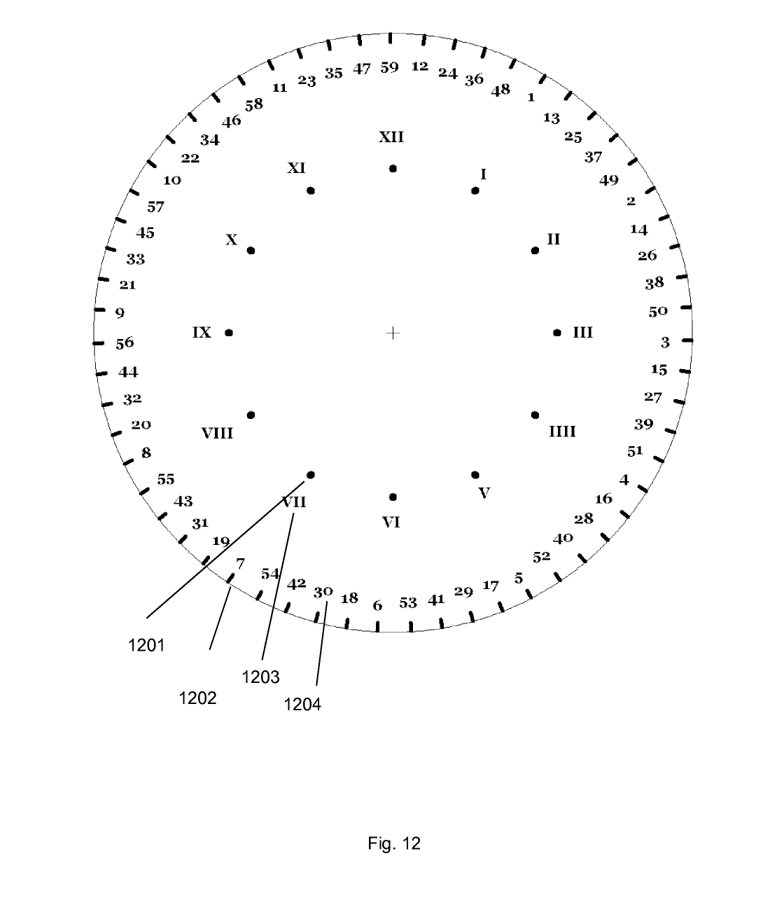

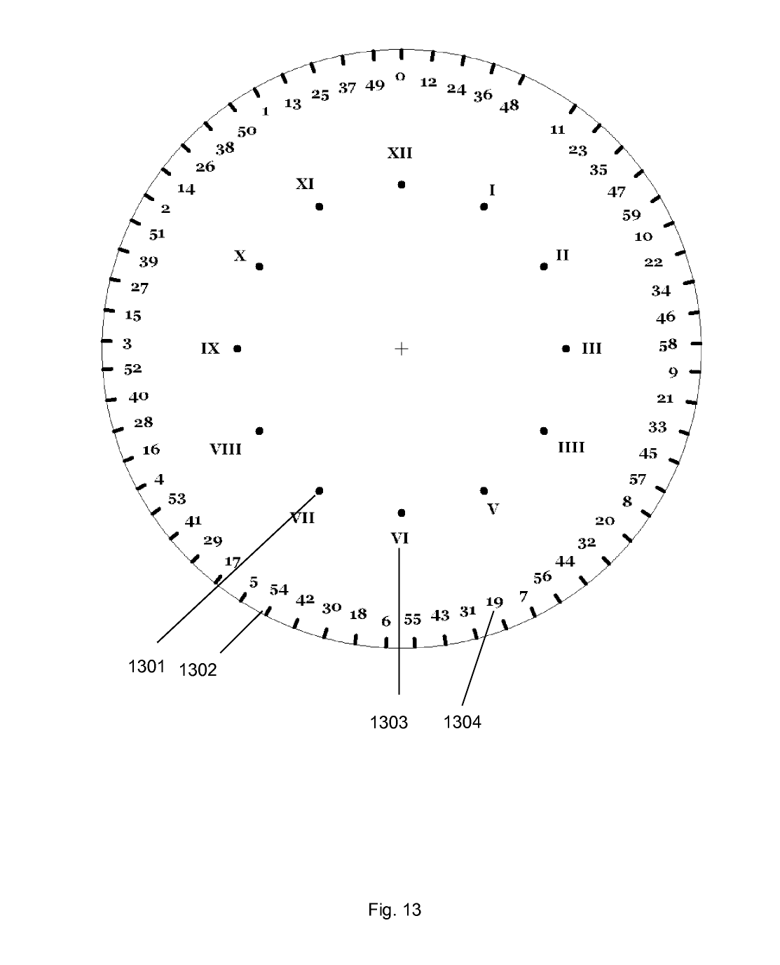

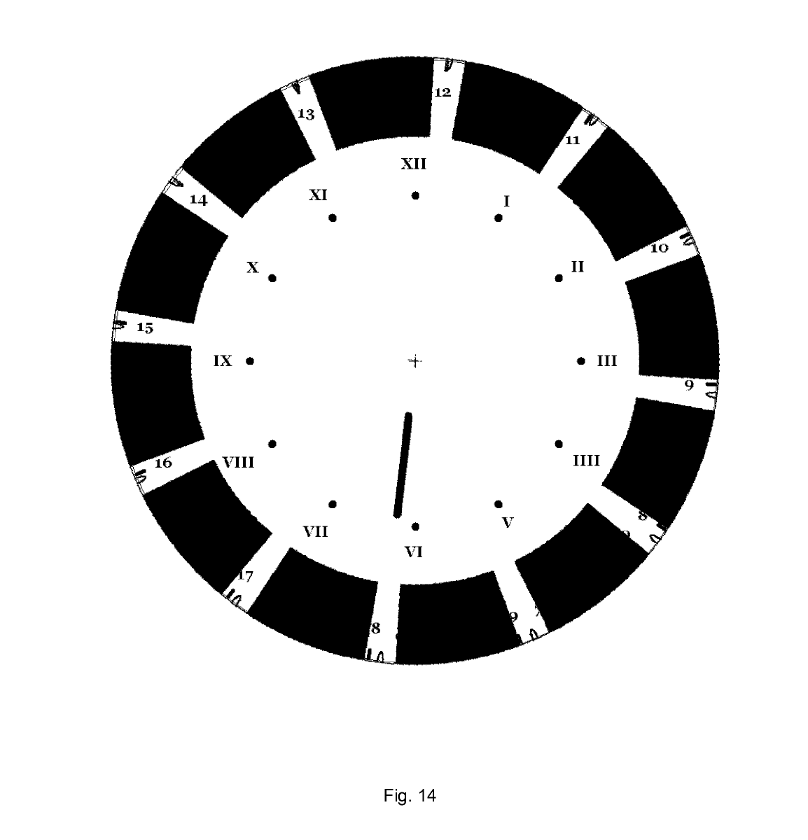

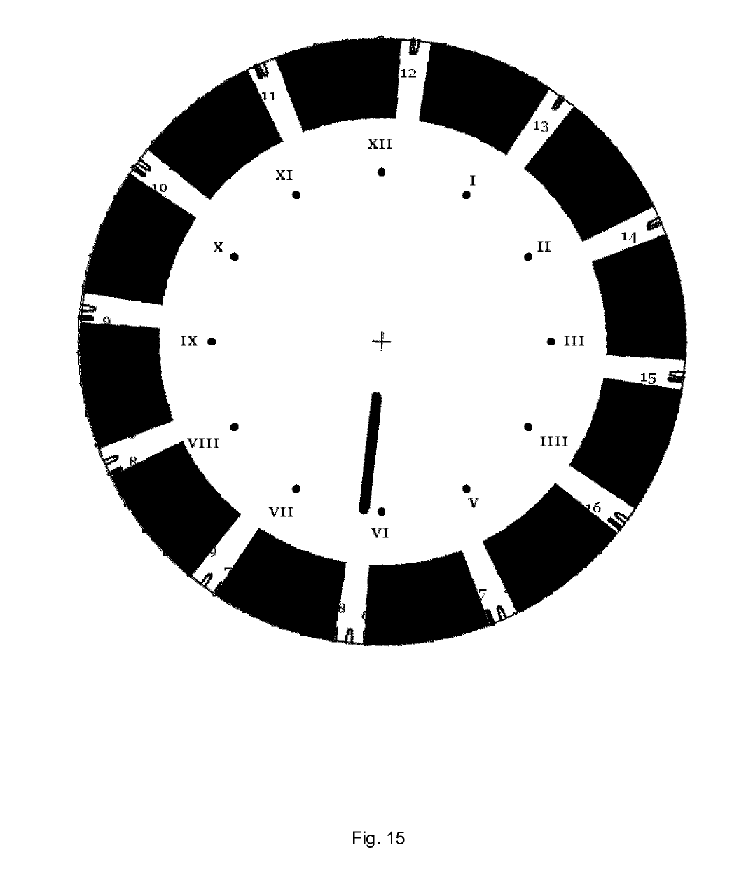

Another embodiment comprises a circular indicator with the roles for the rotating dial and the static face reversed from the embodiments above. In this “reversed” embodiment:
(A) The rotating dial as in FIG. 11 has one major unit alignment marker 1101 and h minor unit alignment markers 1102. The direct static face as in FIG. 12 has h major unit value markers 1201 and m−1 minor unit value markers 1202. The retrograde static face as in FIG. 13 has h major unit value markers 1301 and m minor unit value markers 1302;
(B) The mask 1103 on the rotating dial extends over the static face to mask markings currently not of interest;
(C) Because they are on the static face, the major unit values 1203 and 1303 can be represented in common Roman numerals while the minor unit values 1204 and 1304 can be represented in common Arabic numerals. FIG. 14 indicates a reading of 6:13 using a retrograde face while FIG. 15 indicates 6:13 on a direct face.
   On the rotating dial, the major unit alignment indicator is at the 0 degree position, while minor unit alignment indicators are at angles given by the formula

alpha=j*(360/h) degrees, for j=1 . . . h.

On the fixed face, major unit alignment indicators and their numeric values are at angles

alpha=j*(360/h) degree, for j=1 . . . h

On the direct fixed face, minor unit alignment indicators and their numeric values are at angles

alpha=j*(360/h)+(360/(m*h))) degrees, for j=1 . . . m−1

On the retrograde fixed face, minor unit alignment indicators and their numeric values are at angles

alpha=−(j*((360/h)−(360/(m*h)))) for j=0 . . . m−1

### Still Another Embodiment

A further embodiment comprises a circular indicator with the placement of the rotating dial and the static face inverted from the embodiments above. In this “inverted” embodiment:
(A) The static face is transparent except for its markings;
(B) The rotating dial is immediately underneath the static face; and
(C) The rotating dial is opaque.

### Common Attributes of the Embodiments

These embodiments make it more often feasible to use one moving part rather than two to indicate major and minor units.

These embodiments illustrate how this invention overcomes the following problems of prior art circular indicators:
(a) Limited to the vernier scale approach;
(b) Markings that are very small and close together;
(c) Failure to uniquely depict the value to be indicated;
(d) Markings that are repeated several times; and
(e) Markings that are all visible concurrently.

Further, these embodiments illustrate how this invention improves upon the prior art circular indicators in various ways, including without limitation, the following:
(1) The minor markings are spread around the disk, not compressed into a small portion of the disk. This invention uses a very expanded multi-turn scale that more than circles the dial, typically many times. It does not need a spiral or a sinusoidal curve to prevent subdivision markings from overlapping, being very close to each other or giving ambiguous readings.
(2) Fewer minor markings are required. This invention, when applied to a 12 hour clock face, has 60 indicator marks for all the minutes within 12 hours, whereas the sinusoidal curve one-handed clock face has, in effect, 720.
(3) Adjacent minor markings are not for sequential numbers. In typical vernier scales, each minor marker is adjacent to its numeric predecessor and successor, e.g., 5 is after 4 and before 6. With this invention's hyper-rotated scale, this arrangement is not so. For example, on a “direct 12 hour dial,” 17 precedes the 5 minute marker and then 54 follows it.
(4) Adjacent minor markings are not uniformly spaced apart. With this invention's hyper-extended multi-turn scale, the angles between adjacent minor markings on the rotating dial are not all equal. For example, in the direct 12 hour clock dial, the angles between adjacent markers are 5.5, 6, or 11.5 degrees. In typical vernier scales, all minor markings are equally spaced.
(5) Numeric minor markings use symbols that can be read from any angle. The angular position of the numeric markings varies with the complete numeric value being indicated by the instrument. The 12 of the 7:12 indication is upside down compared to the 12 of 1:12. This invention's preferred implementation labels the markers with domino-like symbols that can be read from any angle rather than with Arabic numeral labels. Arabic and Roman numerals may be used to depict values in the “reversed role” alternative embodiment, because the values' positions are static.
(6) Irrelevant markings are masked to improve readability. In preferred implementations of this indicator panel, most of the currently irrelevant minor indicators are blocked from view to avoid distractions. This reduces the time needed to read the indicator, by drawing the viewer's attention to the panel areas from which readings are made. In some embodiments, this is achieved with a transparent indicator dial and appropriately drawn and positioned dark sections on the fixed face. In other embodiments, the dark sections are on the rotating dial. In still other embodiments, the dark sections can form a fixed mask, placed over an opaque rotating dial.
(7) Appropriately shaped major and minor markings make it easy to notice which measurement values are just above and just below the indicated value.
(8) In addition to the prior described “direct” and “retrograde” embodiments, the invention offers “randomized” embodiments. As described above, in this invention's direct and retrograde embodiments, the sequence of minor division markings is “skip sequential.” This term means that between the markings for minor indications m and m+1 there are generally (m/h)−1 other minor indications. In contradistinction, in the randomized embodiments, there is no such consistent spacing. These randomized embodiments are appropriate preferably for “novelty” indicators.

Although this invention has been described with a certain degree of particularity, it is to be understood that the present disclosure has been made only by way of illustration, and that numerous changes in the details of the composition, construction, and use may be resorted to without departing from the spirit and scope of the invention.

For example, a clock comprises one of the clock face and clock dial embodiments described above and a clock mechanism well known in the prior art. Such a clock is constructed and operates according to methods well known in the prior art.

Further, a compass comprises one of the compass face and compass dial embodiments described above and a compass mechanism well known in the prior art. Such a compass is constructed and operates according to methods well known in the prior art.

I claim:

1. An indicator device comprising:
a first scale comprising a first pivot point and a plurality of first markings, M;
a second scale comprising a second pivot point and a plurality of second markings, H;
wherein M>H+1;
the first and second scales being rotatably connected to each other at the first and second pivot points, along a common axis;
a plurality of indications, each of the indications corresponding to an alignment of one of the first markings with one of the second markings resulting from the first and second scales being rotated relative to each other around the common axis.

2. The indicator device described in claim 1 wherein a portion of the first scale is masked.

3. The indicator device described in claim 1 wherein a portion of the second scale is masked.

4. The indicator device described in claim 1 wherein the indicator device comprises a clock face.

5. The indicator device described in claim 1 wherein the indicator device comprises a compass face.

6. A method to determine a rotational measurement between a first scale and a second scale which are rotatable around a common axis,
the first scale comprising a plurality of first markings, M;
the second scale comprising a plurality of second markings, H;
wherein M>H+1;
the method comprising the steps of:
selecting a plurality of relative rotational displacements between the first and second scales around the common axis,
creating a plurality of indications, each of the indications corresponding to an alignment of one of the first markings with one of the second markings resulting from the first and second scales being rotated relative to each other around the common axis;
choosing one of the indications, thereby producing a chosen indication;
determining which of the rotational displacements corresponds to the chosen indication, thereby producing a determined rotational displacement; and
setting the rotational measurement to the determined rotational displacement.

7. The method described in claim 6 wherein the first and second scales together comprise a clock face.

8. The method described in claim 6 wherein the first and second scales together comprise a compass face.

9. A plurality of visual representations in one-to-one correspondence with a plurality of numeric values, the visual representations being placeable on an indicator device, each of the visual representations when placed on the device allowing for viewing and accurately interpreting the corresponding numeric value over a wide range of viewing angles.
